(19) United States
(12) Patent Application Publication
(10) Pub. No.: US 2026/0218669 A1
(43) Pub. Date: Jul. 30, 2026

(54) DISPLACEMENT CONTROLLED JOINT

(71) Applicant: Northrop Grumman Systems Corporation, Falls Church, VA (US)

(72) Inventors: Christopher M. Schmit, Garland, UT (US); Jessica Jaye Widrick, Notrh Ogden, UT (US); Michael S. Stevens, Tremonton, UT (US); Richard A. Steele, North Ogden, UT (US)

(21) Appl. No.: 19/041,095

(22) Filed: Jan. 30, 2025

(51) Int. Cl. F02K 9/34

(52) U.S. Cl. CPC F02K 9/343

(57) ABSTRACT

A displacement controlled joint (DCJ) for joining rocket segments is disclosed. The DCJ includes a tang ring and a clevis ring. The tang ring includes a tang neck and a tang displacement control feature (DCF). The tang neck connects a tang ring composite joint clevis to a field joint tang. The tang DCF is formed in and extends into the tang neck. The tang DCF defines an inner radial surface of the tang neck including a recess extending into and radially around the tang neck. The clevis ring includes a clevis neck and a clevis DCF. The clevis neck connects a field joint clevis to a clevis ring composite joint clevis. The clevis DCF is formed in and extends into the clevis neck. The clevis DCF defines a radial surface of the clevis neck including a recess extending into and radially around the clevis neck.

### STATEMENT REGARDING FEDERALLY SPONSORED RESEARCH OR DEVELOPMENT

This invention was made with government support under Contract Number NNM07AA75C awarded by NASA. The government has certain rights in the invention.

### TECHNICAL FIELD

This disclosure relates generally to segmented rocket motors, and more specifically to displacement controlled joints for joining motor segments of segmented rocket motors.

### BACKGROUND

Field joints are joints between motor segments of segmented rocket motors. Field joints use seals and have a capability to withstand and prevent hot gases from the rocket motor escaping the segmented motor since insulation cannot be laid over the top of the field joints to prevent joint pressurization due to segmented constraint. Failure of a field joint may lead to catastrophic failure of the segmented rocket motor.

### BRIEF SUMMARY

In one or more illustrative embodiments, a displacement controlled joint for joining segments of a rocket motor is disclosed. The displacement controlled joint includes a tang ring and a clevis ring. The tang ring includes a first annular shape. The tang ring includes a tang ring composite joint clevis, a field joint tang, a tang neck, and a tang displacement control feature. The tang ring composite joint clevis is configured to receive an end of a first segment case of one of the segments therein. The tang neck connects the tang ring composite joint clevis to the field joint tang. The tang displacement control feature is formed in and extends into the tang neck. The tang displacement control feature defines an inner radial surface of the tang neck including a recess extending into and radially around the tang neck. The clevis ring includes a second annular shape. The clevis ring includes a clevis ring composite joint clevis, a field joint clevis, a clevis neck, and a clevis inner displacement control feature. The clevis ring composite joint clevis is configured to receive an end of a second segment case of another of the segments therein. The field joint clevis is configured to receive the field joint tang therein. The clevis neck connects the field joint clevis to the clevis ring composite joint clevis. The clevis inner displacement control feature is formed in and extends into the clevis neck. The clevis inner displacement control feature defines an inner radial surface of the clevis neck including a recess extending into and radially around the clevis neck.

In one or more illustrative embodiments, a rocket segment of a rocket motor is disclosed. The rocket segment includes a segment case, a tang ring, and a clevis ring. The segment case includes a composite structure including a hollow cylinder shape. The tang ring includes a first annular shape. The tang ring includes a tang ring composite joint clevis, a field joint tang, a tang neck, and a tang displacement control feature. The tang ring composite joint clevis includes a first axial end of the segment case received therein. The field joint tang is configured to be received in a clevis of an adjoining rocket segment of the rocket motor. The tang neck connects the tang ring composite joint clevis to the field joint tang. The tang displacement control feature is formed in and extends into the tang neck. The tang displacement control feature defines an inner radial surface of the tang neck including a recess extending into and radially around the tang neck. The clevis ring includes a second annular shape. The clevis ring includes a clevis ring composite joint clevis, a field joint clevis, a clevis neck, and a clevis inner displacement control feature. The clevis ring composite joint clevis includes a second axial end of the segment case received therein. The field joint clevis is configured to receive a tang of another rocket segment of the rocket motor. The clevis neck connects the field joint clevis to the clevis ring composite joint clevis. The clevis inner displacement control feature is formed in and extends into the clevis neck. The clevis inner displacement control feature defines an inner radial surface of the clevis neck including a recess extending into and radially around the clevis neck.

In one or more illustrative embodiments, a segmented rocket motor is disclosed. The segmented rocket motor includes a first rocket segment and a second rocket segment. The first rocket segment includes a first segment case and a tang ring. The tang ring includes a first annular shape. The tang ring includes a tang ring composite joint clevis, a field joint tang, a tang neck, and a tang displacement control feature. The tang ring composite joint clevis includes an end of the first segment case received therein. The tang neck connects the tang ring composite joint clevis to the field joint tang. The tang displacement control feature is formed in and extending into the tang neck. The tang displacement control feature defines an inner radial surface of the tang neck including a recess extending into and radially around the tang neck. The second rocket segment adjoins the first rocket segment. The second rocket segment includes a second segment case and a clevis ring. The clevis ring includes a second annular shape. The clevis ring includes a clevis ring composite joint clevis, a field joint clevis, a clevis neck, and a clevis inner displacement control feature. The clevis ring composite joint clevis includes an end of the second segment case received therein. The field joint clevis receives the field joint tang therein. The clevis neck connects the field joint clevis to the clevis ring composite joint. The clevis inner displacement control feature is formed in and extends into the clevis neck. The clevis inner displacement control feature defines an inner radial surface of the clevis neck including a recess extending into and radially around the clevis neck.

### BRIEF DESCRIPTION OF THE DRAWINGS

For a detailed understanding of the disclosure, reference should be made to the following detailed description, taken in conjunction with the accompanying drawings, in which like elements have generally been designated with like numerals, and wherein:

FIG. 1 is a perspective view of a segmented rocket motor, in accordance with one or more embodiments;

FIG. 2 is a perspective view of a portion of the segmented rocket motor of FIG. 1;

FIG. 3 is a perspective cutaway view of a displacement controlled joint, in accordance with one or more embodiments;

FIG. 4 is a cross-sectional view of a tang ring of FIG. 3;

FIG. 5 is a perspective cutaway view of the tang ring of FIG. 4;

FIG. 6 is a cross-sectional view of the clevis ring of FIG. 3;

FIG. 7 is a perspective cutaway view of the clevis ring of FIG. 6; and

FIG. 8 is a cross-sectional view of a forward joint, in accordance with one or more embodiments.

### DETAILED DESCRIPTION

In various embodiments, a segmented rocket motor includes one or more displacement controlled joints. The one or more displacement controlled joints include a tang ring and a clevis ring, each of the tang ring and the clevis ring including at least one displacement control feature at a central neck thereof. The at least one displacement control feature of each of the tang ring and the clevis ring may define a minimum radial thickness of the respective central neck and may be configured to maintain a substantial load sharing balance between legs of a respective composite joint clevis of each of the tang ring and the clevis ring. Each composite joint clevis is configured to receive and couple to an end of a rocket segment of the segmented rocket motor.

The illustrations presented herein are not actual views of any system, or any component thereof, but are merely idealized representations, which are employed to describe embodiments of the present invention.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise. For example, these terms may refer to an orientation of elements of any system when utilized in a conventional manner. Furthermore, these terms may refer to an orientation of elements of any system as illustrated in the drawings.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

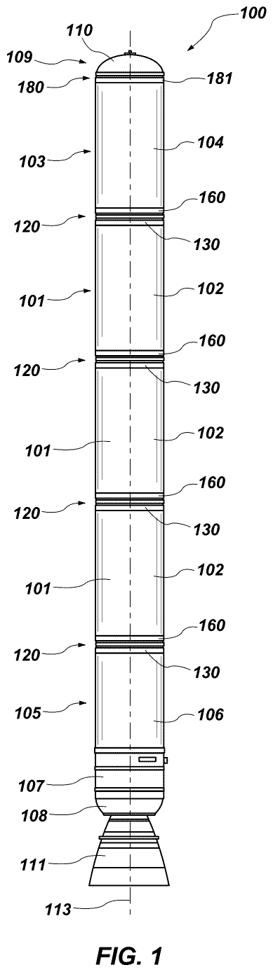

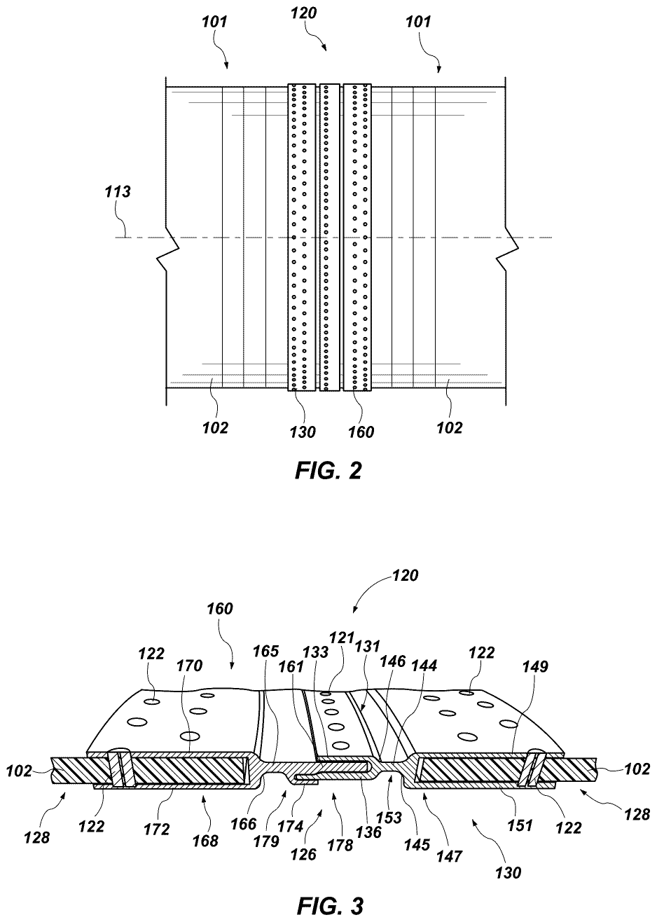

FIG. 1 is a perspective view of a segmented rocket motor 100, in accordance with one or more embodiments. FIG. 2 is a perspective view of a portion of the segmented rocket motor 100 of FIG. 1. In various embodiments, the segmented rocket motor 100 may be a large or small segmented rocket motor (e.g., a Booster Obsolescence Life Extension (BOLE) motor and/or a Reusable Solid Rocket Motor-V (RSRMV), without limitation) and includes multiple rocket segments and displacement controlled joints 120. The multiple rocket segments include one or more center segments 101, a forward segment 103, and an aft segment 105. The multiple rocket segments are joined together via the displacement controlled joints 120. The displacement controlled joints 120 enable composite structures of the rocket segments to be joined together. Each of the displacement controlled joints 120 includes a clevis ring 130 and a tang ring 160 joined together.

The one or more center segments 101 include a segment case 102 and a displacement controlled joint ring chosen from among a clevis ring 130 and a tang ring 160 joined to each axial end thereof. The segment case 102 may include a composite structure. The composite structure may include a hollow cylinder shape (e.g., a right circular hollow cylinder, without limitation).

The forward segment 103 includes a segment case 104 and a displacement controlled ring chosen from among a clevis ring 130 and a tang ring 160 joined to at least one axial end thereof. The segment case 104 may include a composite structure. The composite structure may include a hollow cylinder shape (e.g., a right circular hollow cylinder, without limitation).

The aft segment 105 includes a segment case 106 and a displacement controlled ring chosen from among a clevis ring 130 and a tang ring 160 joined to at least one axial end thereof. The segment case 106 may include a composite structure. The composite structure may include a hollow cylinder shape (e.g., a right circular hollow cylinder, without limitation).

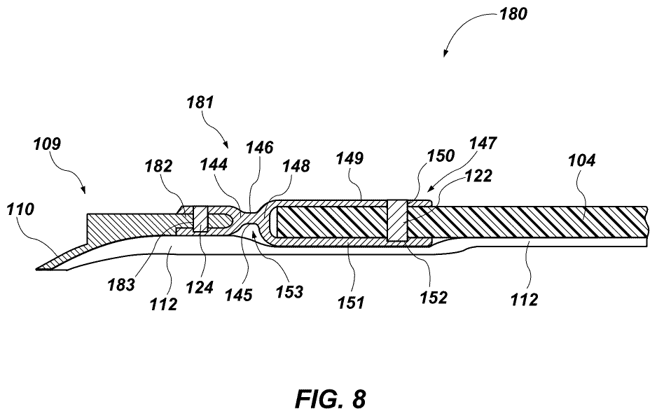

In various embodiments, the segmented rocket motor 100 includes a forward dome 109 joined to the forward segment 103 via a forward joint 180 (discussed in further detail below with regards to FIG. 8). The forward dome 109 may include a dome portion 110 and may include a spherical cap shape (e.g., a hollow spherical cap, without limitation). In various embodiments, the forward joint 180 includes a forward ring 181 that joins the dome portion 110 to the forward segment 103 and that receives the segment case 104 of the forward segment 103. The forward ring 181 may be a component chosen from among a clevis ring 130 and a tang ring 160.

The segmented rocket motor 100 may also include an aft cylinder 107 joined to the segment case 106, an aft dome 108 joined to the aft cylinder 107, and an exhaust nozzle 111 extending from the aft dome 108. The aft cylinder 107 and aft dome 108 may be part of the aft segment 105.

FIG. 3 is a perspective cutaway view of a displacement controlled joint 120, in accordance with one or more embodiments. Referring to FIG. 3, the displacement controlled joint 120 is configured to join two rocket segments together (two center segments 101 are illustrated in FIG. 3). However, the displacement controlled joint 120 may be configured to join the center segment 101 and the forward segment 103 or the center segment 101 and the aft segment 105. The displacement controlled joint 120 may also be used to join together the forward segment 103 and forward dome 109. The displacement controlled joint 120 includes the clevis ring 130, the tang ring 160, field joint pins 121, and factory joint pins (e.g., composite joint pins) 122. The field joint pins 121 are sized and configured for joining the clevis ring 130 and the tang ring 160 together to form a field joint 126 (i.e., the joint formed between the field joint tang 161 and the field joint clevis 131 held together by the field joint pins 121, described in further detail below). The field joint pins 121 may be held in place with a shim. The factory joint pins 122 are sized and configured for joining the clevis ring 130 to a rocket segment in a factory joint 128 and a tang ring 160 to an adjoining rocket segment in a factory joint (e.g., a composite joint) 128. Factory joints 128 may be joints that are formed by a manufacturer at a factory prior to moving the various rocket segments to an assembly site at or near a location for the launch of a rocket or shuttle that includes the segmented rocket motor 100. The field joints 126 are joints between rocket segments that are formed at the assembly site to assemble the segmented rocket motor 100 in preparation for the launch of the rocket or shuttle. The field joints 126 are configured, with the use of O-rings, to form a seal between rocket segments and are configured to withstand and prevent hot motor gases from escaping therethrough. The field joints 126 formed with a displacement controlled joint 120 (i.e., the joint formed between the clevis ring 130 and the tang ring 160) may help limit and minimize rotation that occurs in the field joint 126 at the seal location(s) (e.g., a primary seal 178 and a secondary seal 179, described in further detail below, without limitation), which may reduce the likelihood of seal failure. The field joints 126 may also be used to keep a constant or closing gap between sealing surfaces, reduce non-uniform pin bearing at the factory joint 128 interface, establish a suitable pin bearing on the segment case 102, 104, 106 at the factory joint 128 considering the composite material thereof, and minimize gaps between sealing surfaces for both the primary seal 178 and the secondary seal 179 locations in the segmented rocket motor 100.

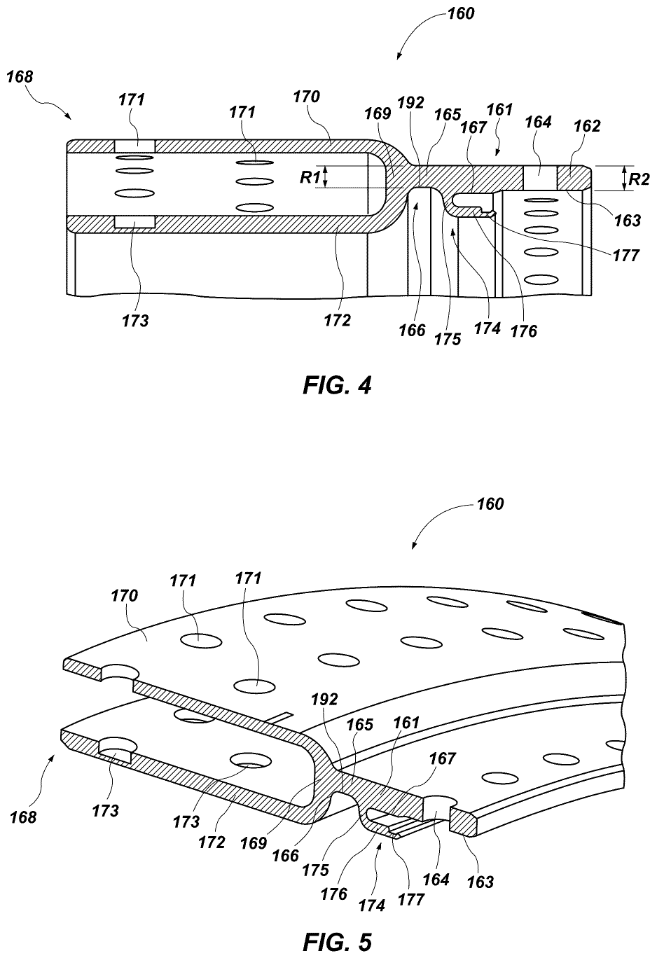

FIG. 4 is a cross-sectional view of the tang ring 160 of FIG. 3. FIG. 5 is a perspective cutaway view of the tang ring 160 of FIG. 4. Referring to FIGS. 3-5, the tang ring 160 includes a field joint tang 161, a tang ring factory joint clevis (e.g., a tang ring composite joint clevis) 168, a tang neck 165 joining the field joint tang 161 to the tang ring factory joint clevis 168, and a tang displacement control feature 166 formed in the tang neck 165.

The field joint tang 161 includes an annular body 162 (e.g., a hollow cylinder, such as a right circular hollow cylinder, without limitation). The field joint tang 161 includes tang through holes 164 formed in and extending through the annular body 162. Each of the tang through holes 164 is sized to receive a field joint pin 121 therethrough. The tang through holes 164 may be evenly spaced and aligned in a row around a circumference of the annular body 162. The field joint tang 161 may include an edge transition (e.g., a chamfer or a fillet, without limitation) between a distal end of the annular body 162 and the tang inner surface 163 and an outer surface of the annular body 162.

In various embodiments, the field joint tang 161 includes a tang inner surface 163 and a tang protrusion 167. The tang inner surface 163 is a radially inner surface of the annular body 162. The tang inner surface 163 may be a cylindrical surface (e.g., a right circular cylinder, without limitation). The tang protrusion 167 extends radially inward, relative to an axis 113 of the segmented rocket motor 100/field joint tang 161, from the annular body 162 proximal to the tang neck 165 with a radially inner surface thereof being positioned radially inward relative to a radial position of the tang inner surface 163.

The tang ring factory joint clevis 168 includes an annular shape with a U-shaped cross-section and is configured to receive and couple the tang ring 160 to an end of a segment case 102, 104 of a rocket segment (e.g., a center segment 101 or a forward segment 103). The tang ring factory joint clevis 168 includes a tang closed end 169, a tang outer leg 170, a tang inner leg 172, tang factory joint through holes (e.g., tang composite joint through holes) 171, and tang factory joint blind holes (e.g., tang composite joint blind holes) 173.

The tang closed end 169, the tang outer leg 170, and the tang inner leg 172 define the annular shape with the U-shaped cross-section of the tang ring factory joint clevis 168 and define an annular opening sized to receive the end of a segment case 102, 104 of a rocket segment.

The tang outer leg 170 includes a hollow cylinder shape (e.g., a right circular hollow cylinder, without limitation) extending axially from the tang closed end 169 in a direction opposite the field joint tang 161. The tang outer leg 170 is offset radially outward relative to a radial position of the field joint tang 161 and the tang neck 165.

The tang inner leg 172 includes a hollow cylinder shape (e.g., a right circular hollow cylinder, without limitation) extending axially from the tang closed end 169 in a direction opposite the field joint tang 161. The tang inner leg 172 is axially aligned with and positioned radially inward from the tang outer leg 170. The tang inner leg 172 is offset radially inward relative to a radial position of the field joint tang 161. The tang inner leg 172 may be positioned radially further from the field joint tang 161 and the tang neck 165 than the tang outer leg 170.

The tang factory joint through holes 171 are formed in and extend through the tang outer leg 170. In various embodiments, the tang factory joint through holes 171 are arranged in one or more rows around a circumference of the tang outer leg 170. The tang factory joint through holes 171 of each row may be evenly spaced around a circumference of the tang outer leg 170. Each row of the tang factory joint through holes 171 may be staggered relative to at least one other row of tang factory joint through holes 171 (e.g., circumferentially offset by about one-half of a circumferential difference between adjoining holes, without limitation).

The tang factory joint blind holes 173 are formed in and extend radially inward, partially into the tang inner leg 172 from a radial outer surface thereof. Each of the tang factory joint blind holes 173 axially and circumferentially aligns with a respective one of the tang factory joint through holes 171 with a substantially similar arrangement as the tang factory joint through holes 171 (e.g., one or more rows, without limitation).

The tang neck 165 is positioned between and joins the field joint tang 161 and the tang ring factory joint clevis 168 together. The tang neck 165 includes an annular shape. The tang neck 165 may include a minimum radial thickness (i.e., an axial location where the radial thickness is the smallest) relatively less than a radial thickness of the field joint tang 161. The tang neck 165 may be radially off-center relative to the tang ring factory joint clevis 168, connecting to the tang closed end 169 at a position radially closer to the tang outer leg 170 than the tang inner leg 172.

The tang displacement control feature 166 includes an annular shape formed in the tang neck 165 including a recess extending into and radially around the tang neck 165. In various embodiments, the tang displacement control feature 166 is formed in a radial inner portion of the tang neck 165 and defines a radial inner surface of the tang neck 165. In various embodiments, the tang displacement control feature 166 is formed in a radial outer portion of the tang neck 165 and defines a radial outer surface of the tang neck 165. In various embodiments, a tang displacement control feature 166 is formed in each of the radial inner portion and radial outer portion of the tang neck 165. The tang displacement control feature 166 may be formed in the tang neck 165 during molding process, an additive manufacturing process or during a machining process.

In various embodiments, the tang displacement control feature 166 defines an annular recess in the tang neck 165, a radial thickness R1 of the tang neck 165 being less than a radial thickness R2 of the annular body 162 of the field joint tang 161. The tang displacement control feature 166 may include a corner transition (e.g., a chamfer or a fillet, without limitation) with structures adjoining the tang neck 165 (e.g., the tang closed end 169, the field joint tang 161, and/or a seal arm 174 (discussed below), without limitation).

The tang displacement control feature 166 may include an apex portion 192 that is an annular line or surface extending furthest into the tang neck 165 (i.e., a radially outermost (when formed at a radially inner portion of the tang neck 165) or innermost (when formed at a radially outer portion of the tang neck 165) portion of the tang displacement control feature 166). The apex portion 192 may include a cylindrical surface (e.g., a right circular cylindrical portion, without limitation) or a maximum position of an annular surface with a curved cross-section (e.g., the maximum point on an arcuate cross-section with either a constant or non-constant radius, without limitation). The apex portion may be positioned at and define a minimum thickness of the tang neck 165. In various embodiments, the apex portion at an inner surface of the tang neck 165 is positioned radially outward relative to a radial position of the tang inner surface 163. The radial positioning of the apex portion 192 relative to the tang inner leg 172 may maximize the structural capability of the center segment 101.

The tang displacement control feature 166 is configured to ensure primary rotation of the tang ring 160 occurs at the tang neck 165 and reduces any displacements in other portions of the tang ring 160, such as portions at interfaces of the tang ring 160 (e.g., the interface of the field joint tang 161 with the clevis ring 130, without limitation). The tang displacement control feature 166 is configured to maintain a substantial load sharing balance between the tang outer leg 170 and tang inner leg 172 while still supporting and minimizing rotation in the field joint 126. A load sharing balance between the tang outer leg 170 and tang inner leg 172 may range from about 40% to 60% to about 60% to 40%, such as about 50%. In various embodiments, a substantial load sharing balance is at least about a 45% and 55% split in load sharing between the tang outer leg 170 and tang inner leg 172. The load sharing balance may optimize the structural capability of the segment case 102, 104, or 106 received in the tang ring factory joint clevis 168.

In various embodiments, the tang ring 160 includes a seal arm 174 and an arm O-ring groove 177. The seal arm 174 includes an annular shape positioned radially inward from the field joint tang 161. The seal arm 174 includes a radial portion 175 and an arm portion 176. The radial portion 175 extends radially inward from the field joint tang 161 (e.g., from the tang protrusion 167, without limitation). The arm portion 176 extends axially away from the tang neck 165. The radial portion 175 and the arm portion 176 form a U-shaped opening with the field joint tang 161. The at least one arm O-ring groove 177 is formed on a radially outer surface of the seal arm 174 (i.e., a surface facing towards the field joint tang 161) at or adjacent to an end of the seal arm 174 distal to the radial portion 175. Each of the at least one arm O-ring grooves 177 includes a depression formed in the seal arm 174 sized to receive an O-ring therein.

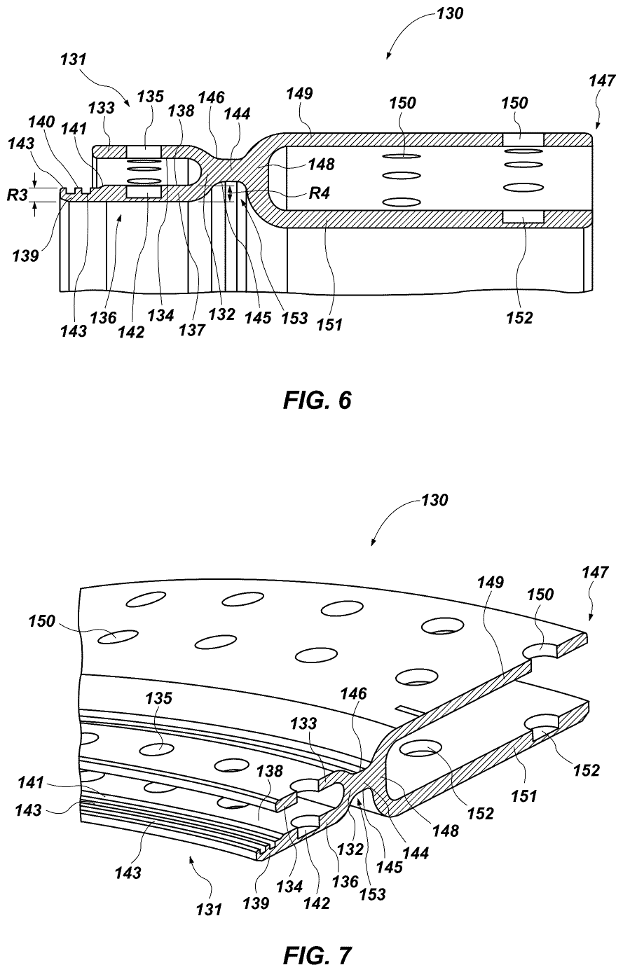

FIG. 6 is a cross-sectional view of the clevis ring 130 of FIG. 3. FIG. 7 is a perspective cutaway view of the clevis ring 130 of FIG. 6. Referring to FIGS. 3, 6, and 7, the clevis ring 130 includes a field joint clevis 131, a clevis ring factory joint clevis (e.g., clevis ring composite joint clevis) 147, a clevis neck 144 joining the field joint clevis 131 to the clevis ring factory joint clevis 147, and a clevis displacement control feature 153.

The field joint clevis 131 includes an annular shape with a U-shaped cross-section configured to receive the field joint tang 161 therein to form the field joint 126 and to couple the clevis ring 130 to the tang ring 160 via the field joint pins 121. The field joint clevis 131 includes a field joint closed end 132, a clevis outer arm 133, a clevis inner arm 136, clevis field joint through holes 135, clevis field joint blind holes 142, and at least one clevis O-ring groove 143.

In various embodiments, the field joint closed end 132, clevis outer arm 133, and clevis inner arm 136 define the annular shape with the U-shaped cross-section of the field joint clevis 131 and the annular opening sized to receive the field joint tang 161.

The clevis outer arm 133 includes a hollow cylinder shape (e.g., a right circular hollow cylinder, without limitation) extending axially from the field joint closed end 132 in a direction opposite the clevis ring factory joint clevis 147 and the clevis neck 144. The clevis outer arm 133 includes an outer arm contact surface 134 configured to contact the field joint tang 161. The outer arm contact surface 134 is a surface facing radially inward toward the clevis inner arm 136. The outer arm contact surface 134 may be a cylindrical surface (e.g., a right circular cylinder, without limitation).

The clevis inner arm 136 includes a hollow cylinder shape (e.g., a right circular hollow cylinder, without limitation) extending axially from the field joint closed end 132 in a direction opposite the clevis ring factory joint clevis 147 and the clevis neck 144. The clevis inner arm 136 is axially aligned with and positioned radially inward from the clevis outer arm 133.

In various embodiments, the clevis inner arm 136 includes an inner arm body 137, an inner arm contact surface 138, and a seal portion 139. The clevis inner arm 136 includes the hollow cylinder shape of the clevis outer arm 133 and extends axially from the field joint closed end 132 in a direction opposite the clevis ring factory joint clevis 147. The inner arm contact surface 138 is a surface facing radially outward toward the clevis outer arm 133. The inner arm contact surface 138 may be a cylindrical surface (e.g., a right circular cylinder, without limitation).

The seal portion 139 includes an annular shape extending axially from an end of the inner arm body 137 distal to the clevis neck 144. The seal portion 139 may extend axially beyond an end of the clevis outer arm 133 distal to the field joint closed end 132. The seal portion 139 may include a seal portion surface 140 and a transition surface 141. The seal portion surface 140 may be positioned radially inward relative to a radial position of the inner arm contact surface 138. The transition surface 141 may extend between the inner arm contact surface 138 and the seal portion surface 140, transitioning between the radial positions of the inner arm contact surface 138 and the seal portion surface 140. The transition surface 141 may include a frustoconical shape. The seal portion 139 may include a radial thickness R3 that is smaller than a radial thickness R4 of the inner arm body 137.

The field joint clevis 131 and the field joint tang 161 are configured to define a primary seal 178, which may include the seal portion 139, the at least one arm O-ring groove 177, and O-rings received in the at least one arm O-ring groove 177.

The seal portion 139 is received in an opening defined between the seal arm 174 and the field joint tang 161 (e.g., between the arm portion 176 and the tang protrusion 167, without limitation) and defines a secondary seal 179 along with O-rings received within the at least one arm O-ring groove 177. The seal portion 139 may include a radial thickness that is larger than a radial opening defined between the seal arm 174 and the field joint tang 161 (e.g., between the arm portion 176 and the tang protrusion 167, without limitation), the seal portion 139 being received in the radial opening defined by the seal arm 174 and the field joint tang 161 in an interference condition.

The clevis field joint through holes 135 are formed in and extend through the clevis outer arm 133. In various embodiments, the clevis field joint through holes 135 are arranged in at least one row around a circumference of the clevis outer arm 133. The clevis field joint through holes 135 of the at least one row may be evenly spaced around a circumference of the clevis outer arm 133.

The clevis field joint blind holes 142 are formed in and extend radially inward, partially into the clevis inner arm 136 (e.g., the inner arm body 137, without limitation) from inner arm contact surface 138. Each of the clevis field joint blind holes 142 axially and circumferentially aligns with a respective one of the clevis field joint through holes 135 with a substantially similar arrangement as the clevis field joint through holes 135.

The at least one clevis O-ring groove 143 is formed on a radially outer surface of the clevis inner arm 136 (e.g., the seal portion surface 140, without limitation) at or adjacent to an end of the clevis inner arm 136 distal to the field joint closed end 132. Each of the at least one clevis O-ring grooves 143 includes a depression formed in the clevis inner arm 136 sized to receive an O-ring therein.

The clevis ring factory joint clevis 147 includes a U-shape configured to receive and couple the clevis ring 130 to an end of a segment case 102, 104, 106 of a rocket segment (e.g., a center segment 101, a forward segment 103, or an aft segment 105). The clevis ring factory joint clevis 147 includes a factory joint closed end (e.g., composite joint closed end) 148, a clevis outer leg 149, a clevis inner leg 151, clevis factory joint through holes (e.g., clevis composite joint through holes) 150, and clevis factory joint blind holes (e.g., clevis composite joint blind holes) 152.

The factory joint closed end 148, the clevis outer leg 149, and the clevis inner leg 151 define the U-shape of the clevis ring factory joint clevis 147 and an opening sized to receive the end of a segment case 102, 104, 106 of a rocket segment.

The clevis outer leg 149 includes a hollow cylinder shape (e.g., a right circular hollow cylinder, without limitation) extending axially from the factory joint closed end 148 in a direction opposite the field joint clevis 131.

The clevis inner leg 151 includes a hollow cylinder shape (e.g., a right circular hollow cylinder, without limitation) extending axially from the factory joint closed end 148 in a direction opposite the field joint clevis 131. The clevis inner leg 151 is axially aligned with and positioned radially inward from the clevis outer leg 149. The clevis inner leg 151 may be positioned radially further from the clevis neck 144 than the clevis outer leg 149.

The clevis factory joint through holes 150 are formed in and extend through the clevis outer leg 149. In various embodiments, the clevis factory joint through holes 150 are arranged in one or more rows around a circumference of the clevis outer leg 149. The clevis factory joint through holes 150 of each row may be evenly spaced around a circumference of the clevis outer leg 149. Each row of the clevis factory joint through holes 150 may be staggered relative to at least one other row of clevis factory joint through holes 150 (e.g., circumferentially offset by about one-half of a circumferential difference between adjoining holes, without limitation).

The clevis factory joint blind holes 152 are formed in and extend radially inward, partially into the clevis inner leg 151 from a radial outer surface thereof. Each of the clevis factory joint blind holes 152 axially and circumferentially aligns with a respective one of the clevis factory joint through holes 150 with a substantially similar arrangement as the clevis factory joint through holes 150 (e.g., one or more rows, without limitation).

The clevis neck 144 is positioned between and joins the field joint clevis 131 and the clevis ring factory joint clevis 147 together. The clevis neck 144 includes an annular shape. The clevis neck 144 may be radially off-center relative to the clevis ring factory joint clevis 147, connecting to the factory joint closed end 148 at a position radially closer to the clevis outer leg 149 than the clevis inner leg 151. The clevis neck 144 may also be radially off-center relative to the field joint clevis 131, connecting to the field joint closed end 132 at a position radially closer to the clevis outer arm 133 than the clevis inner arm 136.

The clevis displacement control feature 153 includes an annular shape formed in the clevis neck 144 and includes at least one recess extending into and radially around the clevis neck 144. In various embodiments, the clevis displacement control feature 153 is formed in a radial inner portion of the clevis neck 144 and defines an inner radial surface 145 of the clevis neck 144. In various embodiments, the clevis displacement control feature 153 is formed in a radial outer portion of the clevis neck 144 and defines an outer radial surface 146 of the clevis neck 144. In various embodiments, the clevis displacement control feature 153 is formed in each of the radial inner portion and radial outer portion of the clevis neck 144. The clevis displacement control feature 153 may be formed in the clevis neck 144 during a molding process, an additive manufacturing process, or during a machining process. The clevis displacement control feature 153 may include a corner transition (e.g., a chamfer or a fillet, without limitation) with structures adjoining the clevis neck 144 (e.g., the factory joint closed end 148 and the field joint closed end 132, without limitation).

The clevis displacement control feature 153 may include an apex portion that is an annular line or surface extending furthest into the clevis neck 144 (i.e., a radially outermost portion (when formed at a radially inner portion of the clevis neck 144) or radially innermost portion (when formed at a radially outer portion of the clevis neck 144)) of the clevis inner displacement control feature 153. The apex portion may include a cylindrical surface (e.g., a right circular cylindrical portion, without limitation) or an annular surface with a curved cross-section (e.g., an arcuate cross-section with either a constant or non-constant radius, without limitation). The apex portion may be positioned at and define a minimum thickness of the clevis neck 144. In various embodiments, the apex portion, when formed at a radially inner portion of the clevis neck 144, is positioned radially outward relative to a radial position of the inner arm contact surface 138. In various embodiments, the apex portion, when formed at a radially outer portion of the clevis neck 144, is positioned radially inward relative to a radial position of the outer arm contact surface 134.

The clevis displacement control feature 153 is configured to ensure primary rotation of the clevis ring 130 occurs at the clevis neck 144 and reduces any displacement in other portions of the clevis ring 130, such as portions at interfaces of the clevis ring 130 (e.g., the interface of the clevis inner arm 136 with the seal arm 174, without limitation). The clevis displacement control feature 153 may be configured to maintain a substantial load sharing balance between the clevis outer leg 149 and the clevis inner leg 151 while still supporting and minimizing rotation in the field joint 126. A load sharing balance between the clevis outer leg 149 and clevis inner leg 151 may range from about 40% to 60% to about 60% to 40%, such as about 50%. In various embodiments, a substantial load sharing balance is at least a 45% and 55% split in load sharing between the clevis outer leg 149 and the clevis inner leg 151. Similarly, the clevis displacement control feature 153 may be configured to maintain a substantial load sharing balance between the clevis outer arm 133 and the clevis inner arm 136 while still supporting and minimizing rotation in the field joint 126. A load sharing balance between the clevis outer arm 133 and the clevis inner arm 136 may range from about 40% to 60% to about 60% to 40%, such as about 50%. In various embodiments, a substantial load sharing balance is at least a 45% and 55% split in load sharing between the clevis outer arm 133 and the clevis inner arm 136.

Referring to FIG. 3, in various embodiments, the location and sizing of the displacement control features (e.g., the tang displacement control feature 166 and/or the clevis displacement control feature 153, without limitation) along with the location and sizing of the tang neck 165 and the clevis neck 144 are configured to control and substantially match an amount of flexion/bending that occurs within each of the clevis ring 130 and the tang ring 160 (e.g., flexion/bending at the tang neck 165 and the clevis neck 144, without limitation) responsive to radial forces applied thereto (e.g., forces caused by joint pressurization), while minimizing an amount of flexion/bending that occurs at the field joint 126 and direct flexion/bending within the clevis ring 130 and the tang ring 160 away from tang and clevis interfaces thereof and to other regions, such as the tang neck 165 and the clevis neck 144. For example, pressurization at the displacement controlled joint 120 during use and operation of the rocket motor 100 may cause outward radial displacement at the field joint 126. A majority of the bending within the clevis ring 130 and the tang ring 160 may occur at the clevis neck 144 due to the clevis displacement control feature 153 and at the tang neck 165 due to the tang displacement control feature 166. The majority of the bending occurring at the clevis neck 144 and the tang neck 165 may help limit and minimize rotation that occurs in the field joint 126 at the seal locations(s) (e.g., the primary seal 178 and the secondary seal 179, without limitation), which may reduce the likelihood of seal failures.

In some of these various embodiments, the clevis neck 144 connects to the clevis ring factory joint clevis 147 at a radial position offset from a radial center of the clevis ring factory joint clevis 147 (e.g., the clevis neck 144 connects to the factory joint closed end 148 at a radial position closer to the clevis outer leg 149 than the clevis inner leg 151, without limitation). The clevis neck 144 and the tang neck 165 may be substantially radially aligned.

In various embodiments, a radial thickness of the clevis neck 144 is about the same as a radial thickness of the tang neck 165. In some of these various embodiments, a radial position of an outer radial surface of the tang neck 165 (e.g., an apex of the radial outer surface, without limitation) is at about a same radial position as the outer radial surface 146 of the clevis neck 144 (e.g., an outer apex of the clevis outer displacement control feature 153, without limitation). In some of these various embodiments, a radial position of an inner radial surface of the tang neck 165 (e.g., an apex of the radial inner surface of the tang neck 165, without limitation) is at about a same radial position as the inner radial surface 145 of the clevis neck 144 (e.g., an inner apex of the clevis displacement control feature 153, without limitation). In various embodiments, an axial width of the clevis displacement control feature 153 is about the same as an axial width of the tang displacement control feature 166 located at an inner portion of the tang neck 165.

The positioning of the clevis neck 144 and the tang neck 165 may position a line of action during outward radial deflection of the displacement controlled joint 120 on the factory joints 128 that substantially balances the load sharing in each factory joint 128. The outward radial deflection may be caused by pressurization at the field joints 126, which may not have insulation over the top thereof. The balanced load sharing may equalize the pin bearing on the factory joint pins 122 on each side of the clevis (i.e., the tang ring factory joint clevis 168 and the clevis ring factory joint clevis 147) of each factory joint 128.

FIG. 8 is a cross-sectional view of a forward joint 180, in accordance with one or more embodiments. Referring to FIG. 8, insulation 112 may be positioned radially inward of the forward joint 180 and other factory joints 128. The forward dome 109 includes a dome joint structure 182 extending from the dome portion 110. The dome joint structure 182 may be a structure chosen from among a tang or a clevis, which may include the same or similar features to the field joint tang 161 (including the tang neck 165 and tang displacement control feature 166) or the field joint clevis 131 (including the clevis neck 144 and the clevis ring displacement control feature), without limitation. The dome portion 110 and the dome joint structure 182 may be integrally formed as a unitary structure.

The forward joint 180 includes the forward ring 181, the dome joint structure 182, forward joint holes 183 formed in the forward ring 181 and the dome joint structure 182, and forward pins 124. The forward joint 180 may be another factory joint (e.g., a joint formed by a manufacturer at a factory prior to moving the various rocket segments to an assembly site at or near a location for the launch of a rocket or shuttle that includes the segmented rocket motor 100, without limitation), and the forward pins 124 may be substantially similar to the field joint pins 121 or the factory joint pins 122.

As noted above, the forward ring 181 may be a structure chosen from among a clevis ring 130 and a tang ring 160, the forward ring 181 including a displacement control feature. In various embodiments, the forward ring 181 is a clevis ring 130, and the dome joint structure 182 includes a tang that mates with the clevis of the clevis ring 130. In other various embodiments, the forward ring 181 is a tang ring 160, and the dome joint structure 182 includes a clevis that mates with the tang of the tang ring 160. Similar to the other displacement control features discussed herein, the displacement control feature of the forward joint 180 may be configured to maintain a substantial load sharing balance between legs of the clevis (e.g., the clevis ring factory joint clevis 147 or the tang ring factory joint clevis 168, without limitation). A load sharing balance between the legs of the forward ring 181 may range from about 40% to 60% to about 60% to 40%, such as about 50%. In various embodiments, a substantial load sharing balance is at least a 45% and 55% split in load sharing between the legs of the forward ring 181.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A displacement controlled joint for joining segments of a rocket motor, the displacement controlled joint comprising:
a tang ring including a first annular shape, the tang ring comprising:
a tang ring composite joint clevis configured to receive an end of a first segment case of one of the segments therein;
a field joint tang;
a tang neck connecting the tang ring composite joint clevis to the field joint tang; and
a tang displacement control feature formed in and extending into the tang neck, the tang displacement control feature defining an inner radial surface of the tang neck including a recess extending into and radially around the tang neck; and
a clevis ring including a second annular shape, the clevis ring comprising:
a clevis ring composite joint clevis configured to receive an end of a second segment case of another of the segments therein;
a field joint clevis configured to receive the field joint tang therein;
a clevis neck connecting the field joint clevis to the clevis ring composite joint clevis; and
a clevis displacement control feature formed in and extending into the clevis neck, the clevis displacement control feature defining a surface chosen from among an inner radial surface of the clevis neck and an outer radial surface of the clevis neck, the clevis displacement control feature including a recess extending into and radially around the clevis neck.

2. The displacement controlled joint of claim 1, wherein the tang displacement control feature defines a minimum thickness of the tang neck and the clevis displacement control feature defines a minimum thickness of the clevis neck, and wherein the minimum thickness of the tang neck is smaller than a thickness of the field joint tang.

3. The displacement controlled joint of claim 1, wherein the tang ring composite joint clevis includes a tang outer leg and a tang inner leg positioned radially inward from the tang outer leg, and the clevis ring composite joint clevis includes a clevis outer leg and a clevis inner leg positioned radially inward from the clevis outer leg, and
wherein the tang displacement control feature is configured to maintain a load sharing balance of at least a 45% and 55% split in load sharing between the tang outer leg and the tang inner leg, and the clevis displacement control feature is configured to maintain a load sharing balance of at least a 45% and 55% split in load sharing between the clevis outer leg and the clevis inner leg.

4. The displacement controlled joint of claim 1, wherein:
the tang ring composite joint clevis includes a tang closed end, a tang outer leg extending axially from the tang closed end, and a tang inner leg extending axially from the tang closed end and positioned radially inward from the tang outer leg;
the clevis ring composite joint clevis includes a composite joint closed end, a clevis outer leg extending axially from the composite joint closed end, and a clevis inner leg extending axially from the composite joint closed end and positioned radially inward from the clevis outer leg;
the tang neck being radially off-center relative to the tang ring composite joint clevis and connecting to the tang closed end at a position radially closer to the tang outer leg than the tang inner leg; and
the clevis neck being radially off-center relative to the clevis ring composite joint clevis and connecting to the composite joint closed end at a position radially closer to the clevis outer leg than the clevis inner leg.

5. The displacement controlled joint of claim 1, wherein the tang displacement control feature includes an apex portion defining a radially outermost portion of the inner radial surface of the tang neck, the apex portion being positioned radially outward of a radial position of an inner surface of the field joint tang.

6. The displacement controlled joint of claim 1, wherein the recess of the clevis displacement control feature defines at least a portion of the inner radial surface, the clevis displacement control feature including a second recess defining at least a portion of the outer radial surface of the clevis neck, and wherein an outer apex of the outer radial surface at least partially axially overlaps with an inner apex of the inner radial surface.

7. The displacement controlled joint of claim 1, wherein:
the tang ring includes:
a seal arm including a radial portion extending radially inward from the field joint tang and an arm portion extending axially from the radial portion defining a U-shaped opening with the radial portion and the field joint tang; and
an arm O-ring groove formed in a radial outer surface of the arm portion, the arm O-ring groove configured to receive a first O-ring; and
the field joint clevis includes:
a field joint closed end connected to the clevis neck;
a clevis outer arm extending axially from the field joint closed end in a direction away from the clevis neck; and
a clevis inner arm extending axially from the field joint closed end in the direction away from the clevis neck, the clevis inner arm including an inner arm body positioned radially inward from the clevis outer arm, a seal portion extending axially from the inner arm body beyond an axial end of the clevis outer arm, the seal portion configured to be received in the U-shaped opening of the tang ring, and at least one clevis O-ring groove formed in a radially outer surface of the seal portion.

8. A rocket segment of a rocket motor, comprising:
a segment case comprising a composite structure including a hollow cylinder shape;
a tang ring including a first annular shape, the tang ring comprising:
a tang ring composite joint clevis with a first axial end of the segment case received therein;
a field joint tang configured to be received in a clevis of an adjoining rocket segment of the rocket motor;
a tang neck connecting the tang ring composite joint clevis to the field joint tang; and
a tang displacement control feature formed in and extending into the tang neck, the tang displacement control feature defining an inner radial surface of the tang neck including a recess extending into and radially around the tang neck; and
a clevis ring including a second annular shape, the clevis ring comprising:
a clevis ring composite joint clevis with a second axial end of the segment case received therein;
a field joint clevis configured to receive a tang of another rocket segment of the rocket motor;
a clevis neck connecting the field joint clevis to the clevis ring composite joint clevis; and
a clevis displacement control feature formed in and extending into the clevis neck, the clevis displacement control feature defining a radial surface of the clevis neck including a recess extending into and radially around the clevis neck.

9. The rocket segment of claim 8, wherein a minimum thickness of the tang neck includes a thickness smaller than the field joint tang.

10. The rocket segment of claim 8, wherein the tang displacement control feature is configured to maintain a substantial load sharing balance between legs of the tang ring composite joint clevis, and the clevis inner displacement control feature is configured to maintain a substantial load sharing balance between legs of the clevis ring composite joint clevis.

11. The rocket segment of claim 8, wherein:
the tang neck is radially off-center relative to the tang ring composite joint clevis, the tang neck connecting to the tang ring composite joint clevis radially outward from a radial center of the tang ring composite joint; and
the clevis neck is radially off-center relative to the clevis ring composite joint clevis, the clevis neck connecting to the clevis ring composite joint clevis radially outward from a radial center of the clevis ring composite joint clevis.

12. The rocket segment of claim 8, wherein the tang displacement control feature includes an apex portion defining a radially outermost portion of an inner surface of the tang neck, the apex portion being positioned radially outward of a radial position of an inner surface of the field joint tang.

13. The rocket segment of claim 8, wherein the clevis outer displacement control feature defines an inner radial surface and an outer radial surface of the clevis neck and the recess defines at least a portion of the inner radial surface, the clevis displacement control feature including a second recess defining at least a portion of the outer radial surface and extending into and radially around the clevis neck, and wherein an outer apex of the outer radial surface at least partially axially overlaps with an inner apex of the inner radial surface.

14. The rocket segment of claim 8, wherein:
the tang ring includes:
a seal arm including a radial portion extending radially inward from the field joint tang and an arm portion extending axially from the radial portion defining a U-shaped opening with the radial portion and the field joint tang; and
an arm O-ring groove formed in a radial outer surface of the arm portion, the arm O-ring groove configured to receive a first O-ring; and
the field joint clevis includes:
a field joint closed end connected to the clevis neck;
a clevis outer arm extending axially from the field joint closed end in a direction away from the clevis neck; and
a clevis inner arm extending axially from the field joint closed end in the direction away from the clevis neck, the clevis inner arm including an inner arm body positioned radially inward from the clevis outer arm, a seal portion extending axially from the inner arm body beyond an axial end of the clevis outer arm, the seal portion configured to be received in the U-shaped opening, and at least one clevis O-ring groove formed in a radially outer surface of the seal portion.

15. A segmented rocket motor, comprising:
a first rocket segment comprising:
a first segment case; and
a tang ring including a first annular shape, the tang ring comprising:
a tang ring composite joint clevis with an end of the first segment case received therein;
a field joint tang;
a tang neck connecting the tang ring composite joint clevis to the field joint tang; and
a tang displacement control feature formed in and extending into the tang neck, the tang displacement control feature defining an inner radial surface of the tang neck including a recess extending into and radially around the tang neck; and
a second rocket segment adjoining the first rocket segment and comprising:
a second segment case; and
a clevis ring including a second annular shape, the clevis ring comprising:
a clevis ring composite joint clevis with an end of the second segment case received therein;
a field joint clevis receiving the field joint tang therein;
a clevis neck connecting the field joint clevis to the clevis ring composite joint clevis; and
a clevis displacement control feature formed in and extending into the clevis neck, the clevis displacement control feature defining a radial surface of the clevis neck including a recess extending into and radially around the clevis neck.

16. The segmented rocket motor of claim 15, wherein the tang displacement control feature defines a minimum thickness of the tang neck and the clevis inner displacement control feature defines a minimum thickness of the clevis neck, and wherein the minimum thickness of the tang neck is smaller than a thickness of the field joint tang.

17. The segmented rocket motor of claim 15, wherein the tang ring composite joint clevis includes a tang outer leg and a tang inner leg positioned radially inward from the tang outer leg, and the clevis ring composite joint clevis includes a clevis outer leg and a clevis inner leg positioned radially inward from the clevis outer leg, and
wherein the tang displacement control feature is configured to maintain a load sharing balance of at least a 45% and 55% split in load sharing between the tang outer leg and the tang inner leg, and the clevis inner displacement control feature is configured to maintain a load sharing balance of at least a 45% and 55% split in load sharing between the clevis outer leg and the clevis inner leg.

18. The segmented rocket motor of claim 15, wherein:
the tang ring includes:
a seal arm including a radial portion extending radially inward from the field joint tang and an arm portion extending axially from the radial portion defining a U-shaped opening with the radial portion and the field joint tang; and
an arm O-ring groove formed in a radial outer surface of the arm portion, the arm O-ring groove configured to receive a first O-ring; and
the field joint clevis includes:
a field joint closed end connected to the clevis neck;
a clevis outer arm extending axially from the field joint closed end in a direction away from the clevis neck; and
a clevis inner arm extending axially from the field joint closed end in the direction away from the clevis neck, the clevis inner arm including an inner arm body positioned radially inward from the clevis outer arm, a seal portion extending axially from the inner arm body beyond an axial end of the clevis outer arm, the seal portion configured to be received in the U-shaped opening, and at least one clevis O-ring groove formed in a radially outer surface of the seal portion.

19. The segmented rocket motor of claim 15, further comprising:
a forward dome including a dome portion and a dome joint structure, the dome joint structure including a structure chosen from among a tang and a clevis,
wherein, one of the first rocket segment and the second rocket segment comprises a forward segment, the forward segment comprising a forward ring chosen from a second tang ring and a second clevis ring, the forward ring forming a forward joint with the dome joint structure.

20. The segmented rocket motor of claim 19, wherein the dome portion and the dome joint structure are integrally formed as a unitary structure.
